(19) United States
(12) Patent Application Publication
(10) Pub. No.: US 2007/0083005 A1
(43) Pub. Date: Apr. 12, 2007

(54) Molding compositions for use in forward lighting applications and headlight components molded therefrom

(75) Inventors: Kurt I. Butler, Kingsville, OH (US); Randall M. Burtt, Conneaut, OH (US)

Correspondence Address: HUDAK & SHUNK CO., L.P.A., Suite 307, 2020 Front Street, Cuyahoga Falls, OH, 44221, US

(73) Assignee: Premix Inc.

(21) Appl. No.: 11/544,216

(22) Filed: Oct. 6, 2006

Related U.S. Application Data
(60) Provisional application No. 60/725,079, filed on Oct. 7, 2005.

(51) Int. Cl. C08G 63/60

(52) U.S. Cl. 524/599

(57) ABSTRACT

The molding compositions of the invention involve the use of liquid thermosetting molding resins based on polyester and compounded with shrink control additives, fillers, reinforcements, and initiators to produce a BMC that can be molded and eliminate polystyrene gel formation or stringing on the molding surface. In particular in a first embodiment, the resins are dissolved in vinyl toluene and curing systems are selected so that the systems can molded below about 345° F. In a second embodiment, styrene is used as a solute for the resin systems but this requires initiators that will cure below 293° F. In addition, the invention relates to products molded from the present compositions, which are suitable in particular for components or parts used in lighting assemblies, and in particular for components used in forward lighting applications, namely parabolic reflectors for use in vehicle headlight assemblies. These parts are typically coated or metallized so as to result in a highly reflective and often intricately configured surface that focuses and intensifies the emitted light.

This application is based on U.S. Provisional Application Ser. No. 60/725,079 filed on Oct. 7, 2005.

### THE FIELD OF THE INVENTION

The field of the invention is molding compositions, and in particular “BMC” or bulk molding compositions, that are particularly suitable for molding components used in forward lighting assemblies. Such assemblies include for example, the parabolic reflector that focuses and projects the light emitted by a vehicle headlamp bulb. These reflectors are subjected to close scrutiny as they serve an important function and further greatly enhance the aesthetics of a vehicle.

The molding compositions of the invention involve the use of liquid thermosetting molding resins with adequate glass transition temperatures, shrink control additives, fillers, reinforcements, and initiators to produce a BMC that can be molded and eliminate polystyrene gel formation from monomeric styrene vapor on the molding surface. It further entails following specific molding temperatures depending on the monomer system used. Further attributes to the compound will be excellent coating adhesion on molded part, non-fogging at lamp operating temperatures, excellent flow into mold during the molding operation, good molded mechanical properties.

In addition, the invention relates to products molded from the present compositions, which are suitable in particular for components or parts used in lighting assemblies, and in particular for components used in forward lighting applications, namely vehicle headlight assemblies. It should be understood, however, that the compositions may have other uses within the ambit of the invention, for example, in electrical components, and the like.

### BACKGROUND OF THE INVENTION

A past issue encountered in the injection molding process used to manufacture vehicle lighting components has been “stringing”, which is a particular surface defect wherein the surface appears to have extraneous tendrils or strings that lay across an otherwise smooth surface. The stringing occurs because of a build-up of uncured polystyrene on the mold surfaces. The cause of the uncured polystyrene is from the formation of monomeric styrene vapor during the molding process. When the vapor cools it condenses on the on the cooler outboard surfaces to form the uncured polystyrene. When this buildup is sufficient enough and when the mold opens a string forms and then falls in onto the part causing a defect when coating of the part is performed. The defect is then deemed not usable and must be discarded. This is a major quality issue not only on the final part but in the process of molding the parts as the tool must be cleaned every 4 hours to prevent the string issue.

In addition, past molding compositions could also encounter problems of incomplete fill and part porosity which are a problem for some of the complex molded profiles seen in headlight parts, such as for example, at the bulb base of the parabola.

The molding compound (BMC) for this invention and subsequent molded articles (Forward Headlight) incorporates special initiator packages, alternate monomers, and specific molding temperatures. This in turn eliminate mold strings and add value to the customer by eliminating an unneeded cleaning process and eliminate scrap caused by mold stringing in their coating line. The savings is significant both in improved product quality and in labor savings in eliminating the constant need to shut down a line to clean the molding apparatus.

### SUMMARY OF THE INVENTION

The molding compositions of the invention involve the use of liquid thermosetting molding resins based on polyester and compounded with shrink control additives, fillers, reinforcements, and initiators to produce a BMC that can be molded and eliminate polystyrene gel formation from monomeric styrene vapor on the molding surface. In particular in a first embodiment, the resins are dissolved in vinyl toluene and curing systems are selected so that the systems can be molded below about 345° F. In a second embodiment, styrene is used as a solute for the resin systems but this requires initiators that will cure below 293° F. These compounds exhibit excellent coating adhesion on molded part; non-fogging at lamp operating temperatures, excellent flow into mold during the molding operation, good molded mechanical properties, and perhaps most significantly, these compounds inhibit problems with mold stringing and significantly reduce the need for constant mold cleaning.

In addition, the invention relates to products molded from the present compositions, which are suitable in particular for components or parts used in lighting assemblies, and in particular for components used in forward lighting applications, namely parabolic reflectors for use in vehicle headlight assemblies. These parts are typically coated or metallized so as to result in a highly reflective and often intricately configured, i.e. crenulated, surface that focuses and intensifies the emitted light.

### BRIEF DESCRIPTION OF THE DRAWINGS

FIG. 1 is a photograph of a Littleford Mixer which can be used for the compounding of the present invention;

FIG. 2 is a first photograph of a KoKneader which can be used for the compounding of the present invention;

FIG. 3 is a second photograph of a KoKneader which can be used for the compounding of the present invention;

FIG. 4 is a photograph of an injection molded headlamp using CL-25640 of the present invention;

FIG. 5 is a photograph of an injection molded headlamp using L-25637 of the present invention;

FIG. 6 is a photograph of an the filled parabola area of an injection molded headlamp of the present invention;

FIG. 7 is a photograph of an the filled bulb socket area of an injection molded headlamp of the present invention;

FIG. 8 is a photograph of a first coated and metallized headlamp of the present invention;

FIG. 9 is a photograph of a second coated and metallized headlamp of the present invention; and

FIG. 10 is a photograph of a headlamp assembly of the present invention;

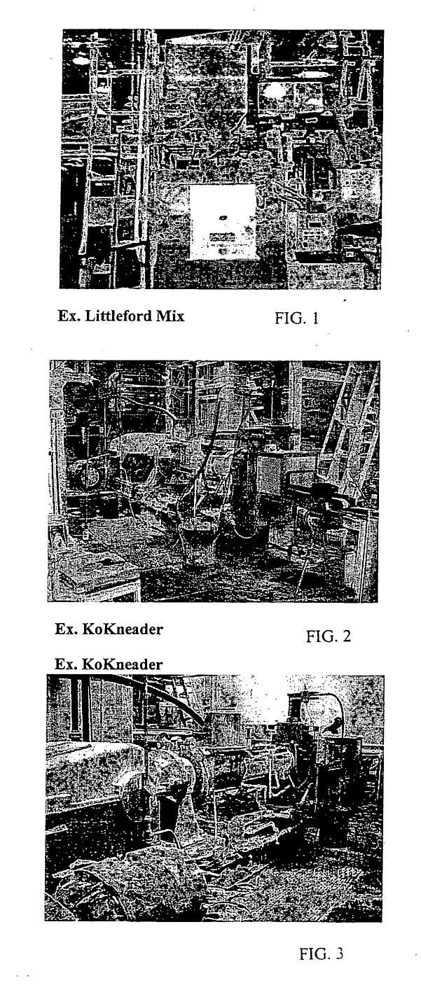

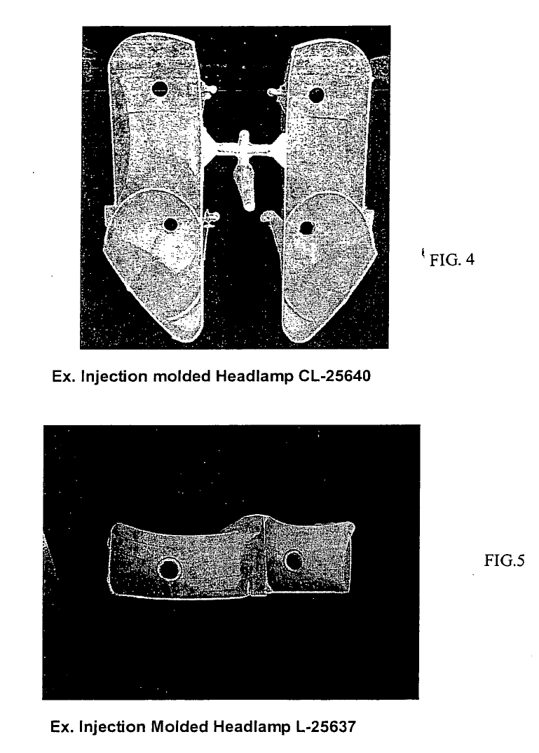

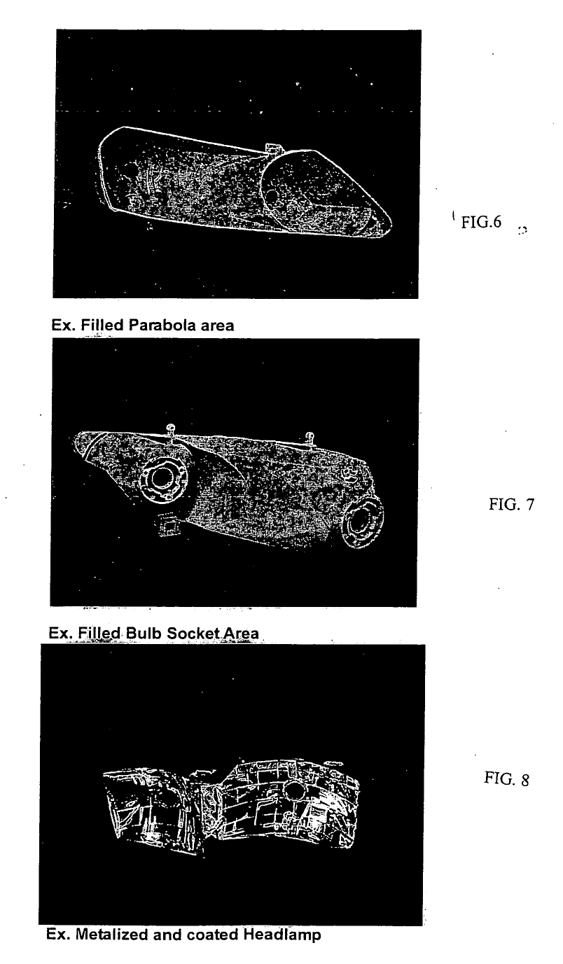

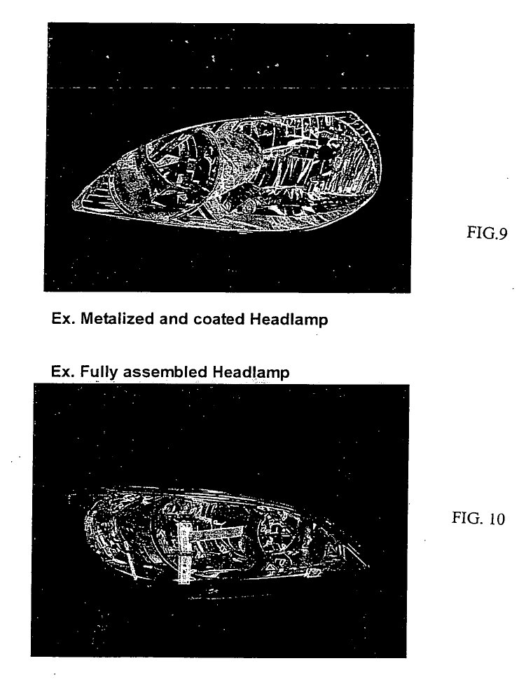

### DETAILED DESCRIPTION OF THE INVENTION

The compositions of the present invention are BMC compounds based on polyester resins, which are typically unsaturated polyester resins and are present in the range of from about 5 to about 20, more preferably from about 7 to about 15, and most preferably about 10 to about 15 percent by weight based on the total weight. Suitable resins can include—MR642 sold by Ashland Chemical, which is a high viscosity, low monomer content resilient reactive resin containing vinyl toluene. As an alternative embodiment of the invention the resin is used in a styrene solution of an saturated polyester resin based on propylene glycol and maleic an anhydride usually used in conjunction with a low profile additive. For this embodiment, a suitable resin is 31615-20X resin sold by Reichhold Chemical.

Additionally, the compound may include a shrink control additive and/or low profile additive. These are typically used in the range of from about 5 to about 15, and preferably from about 5 to about 12, and more preferably from about 5 to about 10 percent based on total weight. A suitable example includes an elastomer, such as Kraton D1101 sold by Shell and which is a linear tri-block copolymer based on styrene and butadiene with a polystyrene content of 31%. Kraton G-1701M can be used, which is a low strength diblock polymer consisting of a hard polystyrene block and a saturated soft poly (ethylene-propylene) block. A more preferred thermoplastic elastomer that can be used is Finaprene 401 which is a radial styrene butadiene block copolymer or alternatively a similar artificial rubber sold under the tradename Calprene by Dynasol USA can be used. Q8OOO is a low profile additive sold by Ashland Chemical that can be used in the second embodiment of the invention in an amount from about 0 to about 5 percent, and preferably from about 0.5 to about 5 percent and more preferably from about 1 to about 4 percent.

The solute used for the first embodiment is vinyl toluene VT-12 sold by Deltech and which is a mixture of metal and para vinyl toluene. In the second embodiment the solute is styrene.

Inhibitors that used can be included IN9083and IN9139 sold by Plasticolors and are less than 1 percent, preferably less than 0.5 percent, and more preferably less than 0.25 percent.

The initiators are paramount to the success of the invention and in the first embodiment function at temperatures below about 360° F., and preferably below about 345° F. and in the second embodiment the initiators function below about 325° F. and more preferably at about 293° F., It may be preferable to use a combination of initiators rather than one, use the total amount being from about 0.25 to about ⅕ percent by weight. For example in one formulation, Triginox BPIC C75 sold by Akzo Nobel can be used as part of an initiator package in an amount ranging from 0.05 to about 0.25 (preferably about 0.075 to about 0.2, and more preferably about 0.1 to about 0.175) percent by weight. Triginox 141 sold by Akzo Nobel which is an alkylperoxester(2,5-dimethyl-2,5 bis (2-tethylhexanoyl-peroxy) hexane, can also be used as a low temperature free radical initiator in this package at an amount of from about 0.1 to about 0.5 (preferably about 0.2 to about 0.4, and more preferably about 0.25 to about 0.35) percent by weight. Triginox D150 sold by Akzo Nobel can be used in an amount ranging from 0.5 to about 0.25 (preferably about 0.75 to about 0.2, and more preferably about 0.1 to about 0.175) percent by weight. In the second embodiment, the package can include from about 0.05 to about 0.3 (preferably about 0.075 to about 0.2, and more preferably about 0.075 to about 0.15) percent by weight of Triginox DC 50 in conjunction with about 0.05 to about 0.5 (preferably about 0.075 to about 0.2, and more preferably about 0.1 to about 0.175) Perkadox AMBN-gr (PDO 210 P50) also sold by Akzo Nobel. A pigment such as black pigment DD111 at a percent of from about 0.25 to about 2, preferably from about 0.5 to about 1.5, and more preferably from about 0.5 to about 1.0 percent. Calcium stearate, can be added in an amount of not more than 2.0 (and preferably from about 0.5 to about 1.5, more preferably from about 0.75 to about 1.5) percent by weight such as COAD 1OC and 710C which is a high grade calcium stearate with a very fine particle size sold by Norac. Fillers can be added at amount from about 25 to about 100 (and preferably from about 50 to about 75, and more preferably from about 50 to about 60) percent by weight As an example, calcium carbonate, such as Omyacarb-3 FL sold by OMYA, Inc. can be used as a filler as can high quality clay, such as ASP-200 sold by Englehard and used at a percentage of about 2 to about 5 percent by weight. Magnesium hydroxide powder 5355D supplied by Ashtabula Trading Company can be used as a thickener at from about 0.1 to about 1.0 and preferably from about 0.2 to about 0.5 percent. Fiberglass fiber can be used in an amount of from about 5 to about 25 and preferably from about 10 to about 25 and more preferably from about 15 to about 20 percent by weight such as shopped strand PPG 3075 sold by PPG chopped in ¼ inch BK length with silane sizing can be used as an reinforcement.

The compounds can be mixed for example in by adding ingredients 1 & 2 according to the Premix formulation cards, (i.e. the resin and solute), and 4-9 (i.e. the low profile, shrink control additives, the pigment, the calcium stearate, and) to a Cowels disperser at about 2,000 to about 4,000 rpm for 1 to 5 minutes. The paste is then transferred to a mixer, which could include a Sigma blade mixer, a Littleford mixer, or a KoKneader where ingredients 11 and 12 (the clay, and the magnesium hydroxide) are added and mixing is conducted for about 15 minutes. Item 14 (the glass fibers) is added, and the paste is mixed for 5 more minutes. After the mixing is complete, the compound is transferred to a banier bag and allowed to mature for two days before use.

Table 1 shows various formulations that can be used for the present invention.

While in accordance with the patent statutes the best mode and preferred embodiment have been set forth, the scope of the invention is not limited thereto, but rather by the scope of the attached claims.

TABLE 1

| | % BOT | PHR | % BOT | PHR | % BOT | PHR | % BOT |
|---|---|---|---|---|---|---|---|
| INGREDIENTS | L-25637 | L-25637 | L-25640 | L-25640 | L-25641 | L-25641 | L-25642 |
| MR-642 | 12.4 | 59.05 | 12.4 | 59.05 | 12.4 | 59.05 | |
| 31615-20X | | | | | | | 12.4 |
| 31615-20X (X4316-87) | | | | | | | |
| X4316-98 | | | | | | | |
| R-144 | 8.6 | 40.95 | 8.6 | 40.95 | 8.6 | 40.95 | 4.8 |
| Q-8000 | | | | | | | 3.8 |
| R-154 | | | | | | | |
| Trig. BPIC-C75 | 0.16 | 0.76 | 0.16 | 0.76 | 0.16 | 0.76 | 0.1 |
| Trig 141 | 0.03 | 0.14 | 0.1 | 0.48 | | | |
| Trig. D-C50 | 0.16 | 0.76 | 0.16 | 0.76 | 0.16 | 0.76 | 0.1 |
| Trig. 21OP50 | | | | | 0.1 | 0.48 | |
| Perkadox AMBN | | | | | | | 0.15 |
| IN-9139 | 0.03 | 0.14 | 0.03 | 0.14 | 0.03 | 0.14 | 0.1 |
| 11-88050 Black Pigment | 0.08 | 0.38 | 0.08 | 0.38 | 0.08 | 0.38 | 0.08 |
| COAD 10C CAST | 1 | 4.76 | 1 | 4.76 | 1 | 4.76 | 1 |
| OMYACARB 3 | 58.29 | 277.57 | 58.22 | 277.24 | 58.22 | 277.24 | 58.22 |
| ASP-200 | 3 | 14.29 | 3 | 14.29 | 3 | 14.29 | 3 |
| MAG. HYDROXIDE POWDER | 0.25 | 1.19 | 0.25 | 1.19 | 0.25 | 1.19 | 0.25 |
| ¼″ In 3075 Glass | 16 | 76.19 | 16 | 76.19 | 16 | 76.19 | 16 |
| | PHR | % BOT | PHR | % BOT | PHR | % BOT | PHR |
| INGREDIENTS | L-25642 | L-25646 | L-25646 | L-25647 | L-25647 | L-25648 | L-25648 |
| MR-642 | | 12.4 | 59.05 | | | | |
| 31615-20X | 59.05 | | | | | | |
| 31615-20X (X4316-87) | | | | 12.4 | 59.05 | | |
| X4316-98 | | | | | | 12.4 | 59.05 |
| R-144 | 22.86 | 8.6 | 40.95 | 8.6 | 40.95 | | |
| Q-8000 | 18.10 | | | | | | |
| R-154 | | | | | | 8.6 | 40.95 |
| Trig. BPIC-C75 | 0.48 | 0.16 | 0.76 | 0.16 | 0.76 | 0.16 | 0.76 |
| Trig 141 | | 0.1 | 0.48 | 0.1 | 0.48 | 0.1 | 0.48 |
| Trig. D-C50 | 0.48 | 0.16 | 0.76 | 0.16 | 0.76 | 0.16 | 0.76 |
| Trig. 21OP50 | | | | | | | |
| Perkadox AMBN | 0.71 | | | | | | |
| IN-9139 | 0.48 | 0.03 | 0.14 | 0.03 | 0.14 | 0.03 | 0.14 |
| 11-88050 Black Pigment | 0.38 | 0.08 | 0.38 | 0.08 | 0.38 | 0.08 | 0.38 |
| COAD 10C CAST | 4.76 | 1 | 4.76 | 1 | 4.76 | 1 | 4.76 |
| OMYACARB 3 | 277.24 | 58.22 | 277.24 | 58.22 | 277.24 | 58.22 | 277.24 |
| ASP-200 | 14.29 | 3 | 14.29 | 3 | 14.29 | 3 | 14.29 |
| MAG. HYDROXIDE POWDER | 1.19 | 0.25 | 1.19 | 0.25 | 1.19 | 0.25 | 1.19 |
| ¼″ In 3075 Glass | 76.19 | 16 | 76.19 | 16 | 76.19 | 16 | 76.19 |

What is claimed is:

1. A parabola for a forward lighting system for a vehicle comprising the coated and metallized molded product of a bulk molding compound comprised of a polyester resin in vinyl toluene, a shrink control additive, reinforcements, fillers, and an initiator that allows the polyester resin to be molded below about 343° F. or a polyester resin in styrene, a shrink control additive, reinforcements, fillers, and an initiator that allows the polyester resin to be molded below about 293° F.

2. A parabola as set forth in claim 1 wherein the polyester resin is an unsaturated polyester resin in toluene or a saturated polyester resin in styrene.

3. A parabola as set forth in claim 2 wherein the shrink control additive is a styrene butadiene copolymer.

4. A parabola as set forth in claim 3 wherein the styrene butadiene copolymer is a radial copolymer.

5. A parabola as set forth in claim 1 wherein the initiator is one or more or Triginox BPIC C75, Triginox 141, Triginox D150, Triginox DC 50 and Perkadox AMBN.

6. A method of making a parabola for a vehicle headlight assembly comprising molding a bulk molding compound comprised of a polyester resin in vinyl toluene shrink control additive, reinforcements, fillers, and an initiator that allows the polyester resin to be molded below about 343° F. or a polyester resin in styrene, a shrink control additive, reinforcements, fillers, and initiator that allows the polyester resin to be molded below about 293° F. and coating the product with a metal coating.

7. A method of making a parabola as set forth in claim 6 wherein the polyester resin is an unsaturated polyester resin in toluene or a saturated polyester resin in styrene.

8. A method of making a parabola as set forth in claim 7 wherein the shrink control additive is a styrene butadiene copolymer.

9. A method of making a parabola as set forth in claim 8 wherein the styrene butadiene copolymer is a radial copolymer.

10. A method of making a parabola as set forth in claim 6 wherein the initiator is one or more or Triginox BPIC C75, Triginox 141, Triginox D150, Triginox DC 50 and Perkadox AMBN.

11. A method of inhibiting stringing in a molded vehicle headlight comprising injection molding a parabola from a bulk molding compounds comprised of a polyester resin in vinyl toluene, a shrink control additive, reinforcements, fillers, and an initial that allows the polyester resin to be molded below about 343° F. or a polyester resin styrene, a shrink control additive, reinforcements, fillers, and an initiator that allows the polyester resin to be molded below about 293° F. and coating the product with a metal coating.

12. A method of inhibiting stringing as set forth in claim 11 wherein the polyester resin is an unsaturated polyester resin in toluene or a saturated polyester resin in styrene.

13. A method of inhibiting stringing as set forth in claim 12 wherein the shrink control additive is a styrene butadiene copolymer.

14. A method of inhibiting stringing as set forth in claim 13 wherein the styrene butadiene copolymer is a radial copolymer.

15. A method of inhibiting stringing as set forth in claim 1 1 wherein the initiator is one or more or Triginox BPIC C75, Triginox 141, Triginox D150, Triginox DC 50 and Perkadox AMBN.
